(19) United States
(12) Patent Application Publication
(10) Pub. No.: US 2010/0307347 A1
(43) Pub. Date: Dec. 9, 2010

(54) MULTI-FUNCTIONAL POT

(76) Inventor: David Menashes, Haifa (IL)

Correspondence Address: William H. Dippert;Eckert Seamans Cherin & Mellott, LLC, U.S. Steel Tower, 600 Grant Street, 44th Floor, Pittsburgh, PA, 15219, US

(21) Appl. No.: 12/682,400

(22) PCT Filed: Oct. 12, 2008
(86) PCT No.: PCT/IL08/01352

§ 371 Date: Aug. 16, 2010

Related U.S. Application Data
(60) Provisional application No. 60/978,790, filed on Oct. 10, 2007.

(51) Int. Cl. A47J 37/00

(52) U.S. Cl. 99/340

(57) ABSTRACT

The present invention presents a multifunctional kitchenware. The multi functional cooking apparatus is used for cooking in different types of cooking methods such as steaming, frying, deep flying, baking and broiling. The multifunctional pot comprises a base module onto which different utensils can be mounted to allow the different types of cooking styles.

### FIELD OF THE INVENTION

The present invention relates to kitchen ware. More particularly, the present invention relates to a multi functional pot that is used for cooking in different cooking methods such as steaming, frying, deep frying, baking, and broiling using a single base module.

### BACKGROUND OF THE INVENTION

The present invention, in some embodiments thereof, relates to a cooking instrument and, more particularly to a cooking instrument that can be used for many different types of cooking methods.

There are many different cooking methods used in a kitchen. Different cooking methods require different utensils since the nature of cooking is changed from one dish to another. For example, a pizza is cooked in a totally different manner from pancakes, steamed vegetables, meat, fish etc. The characteristics of the utensil to be used for the different dishes are significantly different. A pizza is preferably cooked in an oven having a closed space and a heating element above the dish while pancakes are panned on a flat pan placed on top of a heating source and steamed vegetables are cooked in a deeper pot. There is a need for a single dish in which all types of food can be made.

Prior art dealing with these issues include multi-parts cooking apparatus (as disclosed in U.S. Pat. No. 7,412,922 B2 Aug. 19, 2008, U.S. Pat. No. 6,289,793 and U.S. Pat. No. 6,941,857). However, those cooking apparatii are each used for a single type of cooking method e.g., only for frying. There is no dish addressing the use of a multi cooking apparatus that can be easily transformed to utensils of different characteristics.

In contrast, the present invention discloses a cooking apparatus for cooking in different types of cooking methods, such as baking, frying, broiling and steaming.

### SUMMARY OF THE INVENTION

It is an object of the present invention to provide a multi functional pot that is capable of receiving multiple utensils that enable different type of cooking styles.

It is another object of the present invention to provide a multi functional pot that can be transformed from one type of utensil to another in an easier manner.

It is yet another object of the present invention to provide a multi-functional pot having a base module or unit onto which different utensils are mounted so as to enable different types of cooking styles and methods.

It is therefore provided in accordance with a preferred embodiment of the present invention a multifunctional pot assembly comprising
a base module comprises a pot-like base having an upper opening, operation control mechanism, at least one heating element from which a first heating element is positioned in said pot-like base, and an inner cover for concealing said first heating element;
a revolving element attached to a motor; wherein said revolving element extends above said inner cover in said upper opening;
at least one utensil, wherein the utensils can be mounted on said upper opening and are capable of revolving by said revolving element.

Furthermore, in accordance with yet another preferred embodiment of the present invention, the pot has a round shape.

Furthermore, in accordance with yet another preferred embodiment of the present invention, the pot-like base is provided with a mounting axis and a lever extending horizontally from the axis and a lid is mounted on the lever that extends over the opening of the pot-like base and can be position in different heights over the opening.

Furthermore, in accordance with yet another preferred embodiment of the present invention, a second heating element from said at least one heating element is provided within said lever, and can be a griller.

Furthermore, in accordance with yet another preferred embodiment of the present invention, said operation control mechanism controls said at least one heating element through a console having elements such as on/off buttons, control heating level knobs, and indicating lamps.

Furthermore, in accordance with yet another preferred embodiment of the present invention, the pot-like base is provided with supporting legs provided with racks that are capable of serving as storage space for said utensils.

Furthermore, in accordance with yet another preferred embodiment of the present invention, the rim of the sides of said pot-like base is provided with a dent capable of mounting extensions walls of different heights.

Furthermore, in accordance with yet another preferred embodiment of the present invention, the pot further provided with double-walled extension of different heights that can be mounted on said dent in the rim on the pot-like base.

Furthermore, in accordance with yet another preferred embodiment of the present invention, said double-walled extension is provided with third said heating element.

Furthermore, in accordance with yet another preferred embodiment of the present invention, said at least one utensil is a flat shaped pan with small holes.

Furthermore, in accordance with yet another preferred embodiment of the present invention, said at least one utensil is a flat shaped pan provided with folds, a lifted rim and a dent on a circumference of the pan.

Furthermore, in accordance with yet another preferred embodiment of the present invention, said at least one utensil is a flat shaped pan with plurality of flat recesses.

Furthermore, in accordance with yet another preferred embodiment of the present invention, the plurality of flat recesses are interconnected to a central recess.

Furthermore, in accordance with yet another preferred embodiment of the present invention, the pot further provided with a spindle capable of being connected to said revolving element and wherein said spindle is of conical shape allowing said at least one utensil to be mounted on it.

Furthermore, in accordance with yet another preferred embodiment of the present invention, wherein said at least one utensil is a bowl like structure with a raised hole and is capable of being mounted over said spindle.

Furthermore, in accordance with yet another preferred embodiment of the present invention, on top of said bowl like structure mounted a flat pan designed for steaming, wherein said flat pan has holes and axis on the diameter capable of being lifted half said pan on said axis.

Furthermore, in accordance with yet another preferred embodiment of the present invention, said bowl like structure further capable of being mounted over said spindle wherein the spindle extends beyond the bowl surface.

Furthermore, in accordance with yet another preferred embodiment of the present invention, said utensil is a frying net basket capable of being mounted on the spindle inside said bowl and wherein the spindle extends beyond said net basket surface.

Furthermore, in accordance with yet another preferred embodiment of the present invention, said at least one utensil is a rotating pedals mechanism for steering, wherein said rotating pedals are positioned on top of said spindle.

Furthermore, in accordance with yet another preferred embodiment of the present invention, said rotating pedals can be adjusted in any angle relative to a bottom surface of said at last one utensil.

Furthermore, in accordance with yet another preferred embodiment of the present invention, said rotating pedals have an axle around which said rotating pedals can paddle and said rotating pedals can be adjusted each in different angle then the other.

Furthermore, in accordance with yet another preferred embodiment of the present invention, the pot further provided with a skewers utensil capable of being mounted on said revolving element and wherein the skewers may be of different sizes and lengths.

In addition and in accordance with yet another preferred embodiment of the present invention, the pot further provided with a chicken mounting utensil capable of being mounted on said revolving element.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-d illustrate a base module of a multifunctional pot in accordance with a preferred embodiment of the present invention, in different views and states.

FIG. 2 illustrates a multifunctional pot designed for cooking verity of dishes in accordance with a preferred embodiment of the present invention, provided with different types of pans.

FIG. 3 illustrates a multifunctional pot designed for deep frying, in accordance with a preferred embodiment of the present invention, provided with different types of utensils for frying.

FIGS. 4a, b illustrate a multifunctional pot designed for a. cooking and b. steam cooking, in accordance with preferred embodiments of the present invention.

FIG. 5 illustrates a multifunctional pot provided with a verity of utensils in accordance with another preferred embodiment of the present invention.

FIG. 6 illustrates a multifunctional pot provided with a chicken oven utensil in accordance with yet another preferred embodiment of the present invention.

FIGS. 7a, b illustrate multifunctional pot having the cover in different heights, in accordance with another preferred embodiment of the present invention.

### DETAILED DESCRIPTION OF THE INVENTION AND FIGURES

The present invention provides a unique and novel multi functional pot having a base module or unit to which different types of utensils are combined in order to provide different cooking abilities and styles.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”.

The term “consisting essentially of” means that the structure may include additional parts, but only if the additional parts do not materially alter the basic and novel characteristics of the claimed structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing.

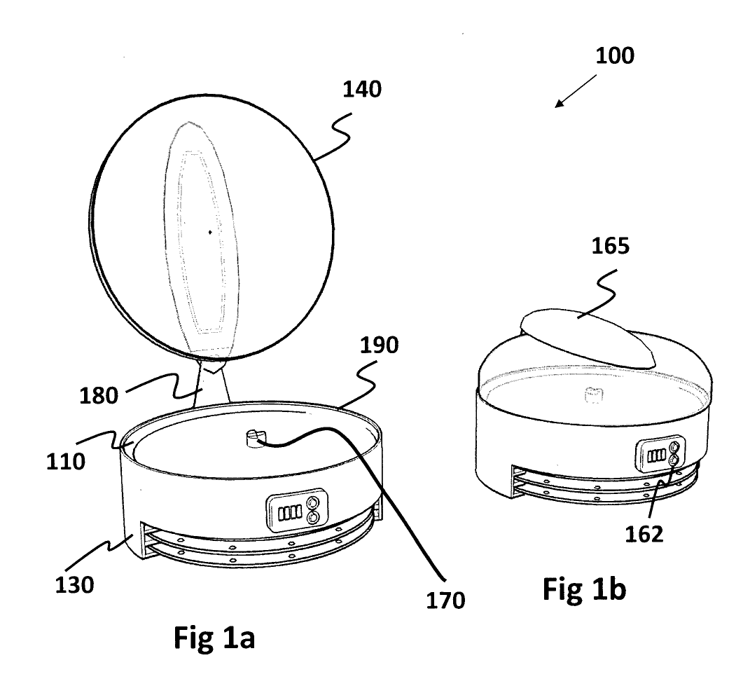

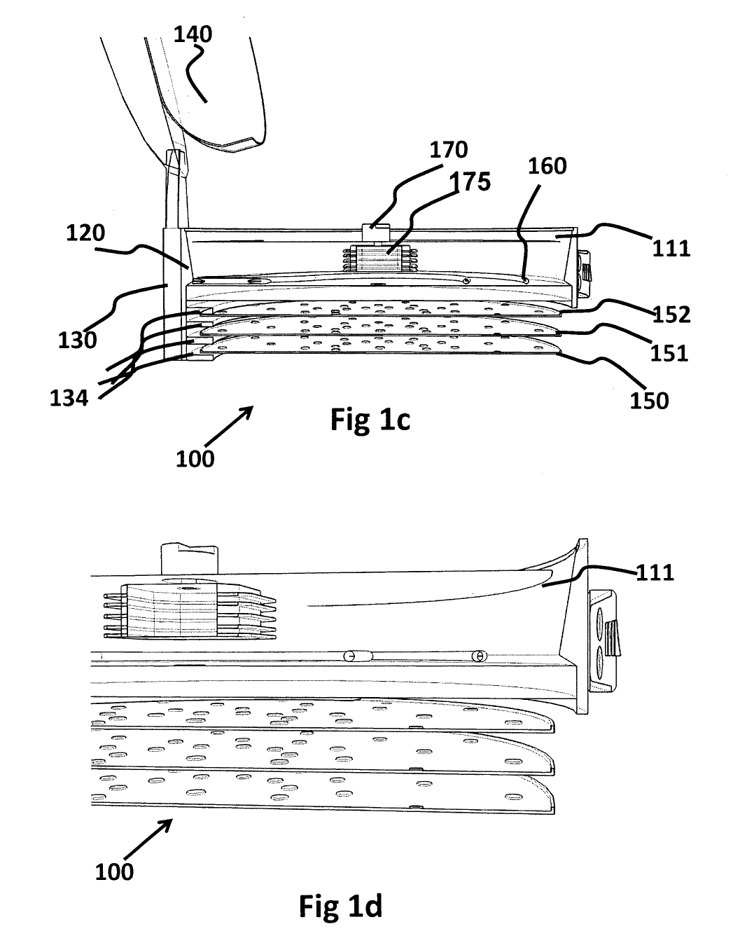

Reference is made to FIGS. 1a, b, c and d illustrating a base module of a multifunctional pot with multiple utensils, in accordance with preferred embodiments of the present invention. FIG. 1a illustrates an isometric view in an open state of the base module, FIG. 1b illustrates an isometric view with a closed lid while FIG. 1c illustrates a cross sectional view of the base module and FIG. 1d illustrates a closer look part of the cross section. Base module 100 is preferably in a bowl's shape having an opening 110 in the upper side. Base module 100 has a cover 140 with cover holding 165 that can be opened and optionally be closed in different heights by raising the cover on its mounting axis 180; it is capable of being raised beyond the level of rim 190. A base 120 is mounted on extensions acting as supporting legs 130. Supporting legs 130 are provided with plurality of racks 134 adapted to receive some of the utensils 150, 151, 152 that will be shown herein after, when they are not in use.

Base 120 contains heating element 160 and a motor 175 that is preferably a stepper motor but can also be a continues one. Heating element 160 and stepper motor 175 are controlled through console 162 having on/off buttons, knobs, and optional indicating lamps as used in the art.

Heating element can be placed in the bottom portion of multifunctional pot 100; however, heating element can also be placed in any other location as well as the sides of the main dish or utensil and in the upper portion, without limiting the scope of the present invention. As an example for top heating and in order to receive additional heat from the top, a heating element can be provided in cover holding 165. Optionally, the top heating element can be provided also with a grill element.

Base module 100 can be provided with a variety of utensils that are capable of being mounted onto or into base module 100 in opening 110. An inner cover 111 is placed internally within base 120 and is adapted to provide support and to conceal heating element 160.

Extension spindle 170 to motor 175 is connected to motor 175 and protrudes through a hole in inner cover 111. Extension spindle 170 acts as the revolving mechanism on top of the pot, onto which verity of utensils are capable of being insert to provide motion to different outlines.

The rim of the bowl of base module 100 is provided with a dent 190 to allow mounting an extension to the walls of the pot in order to extend the sides of the pot and to make it higher for baking purposes such as backing a chicken and form a compartment that resembles an oven. Preferably, base module 100 is provided with handles (not shown in the figures).

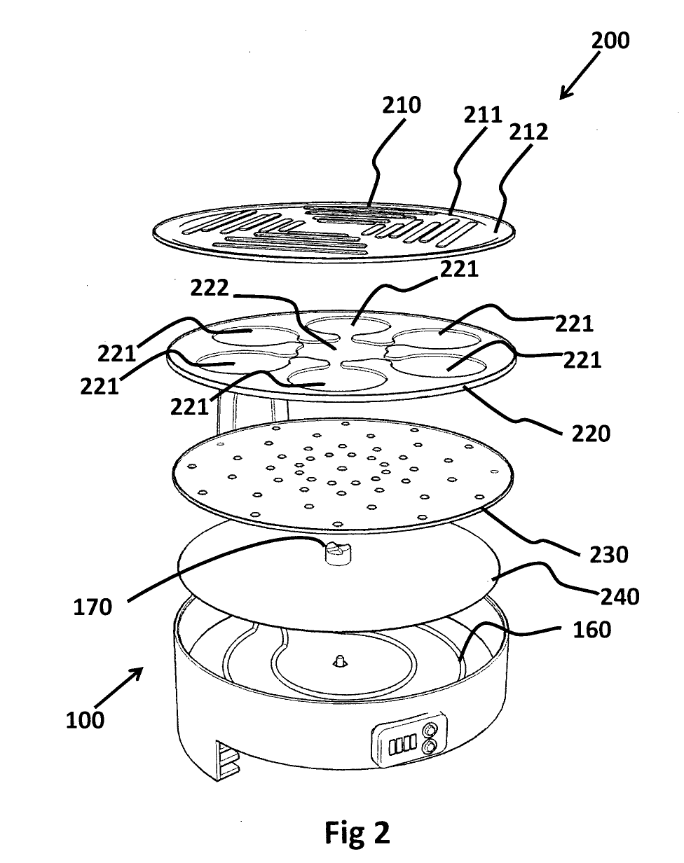

Reference is now made to FIG. 2 illustrating multifunctional pot 200 designed for cooking with a verity of dishes, in accordance with a preferred embodiment of the present invention. The different pans 210, 220, and 230 are all optional pans that can be each mounted on base module 100 shown in FIG. 1; the diameter of the pans fit the diameter of opening 110. Pan 210 that is flat shaped is designed for frying food such as steaks or fish; Pan 210 has a lifted rim 211 and dent 212 both around the outer surrounding for keeping oil dripping from pan 210. Pan 220 that is flat shaped is designed for preparing pancakes; Pan 220 has plurality of flat recesses 221 for shaping the structure of the baking material such as the mixture for pancakes. Preferably, recesses 221 are all connected to each other through a central recess 222; when baking material is poured into recess 222 it spill into recesses 210 and fill them up. Pan 230 that is flat shaped is designed for preparing pizza and crepe dishes; it has plurality of small holes. Pan 240 that is flat shaped is also designed for preparing crepe dishes, and pita bread as example. Optionally, all pans can be rotated by providing a mating element spindle that can be combined to motor extension 170.

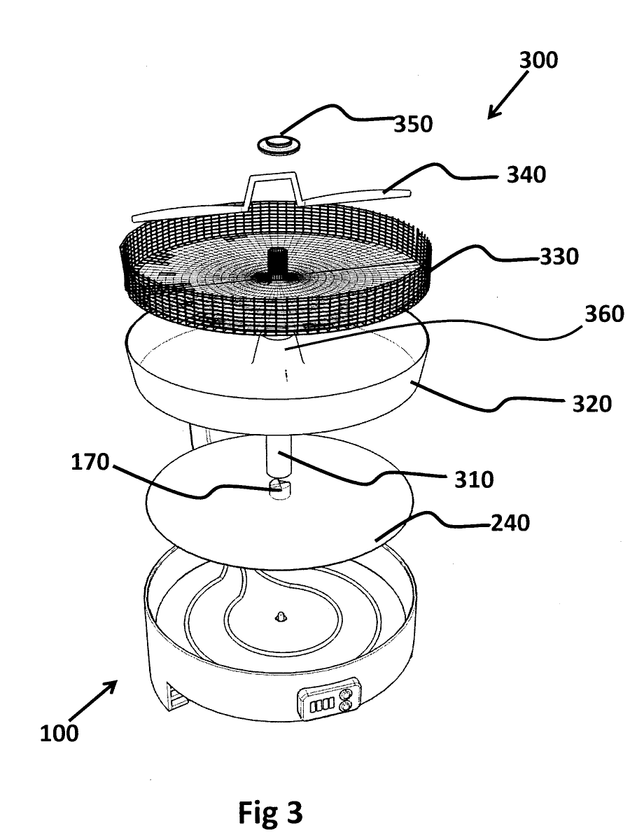

Reference is now made to FIG. 3 illustrating multifunctional pot 300 designed for deep frying, in accordance with a preferred embodiment of the present invention. Base module is provided with an inner cover with motor extension 170. Extension 310 is a supporting ring mounted on motor extension 170 that supports a fluted utensil 320. Utensil 320 is a fluted cake-like pan having a central hole 360 through which extension 310 can pass and support the utensil. Extension 310 is adapted to enable rotation of mixing wings 340 provided within fluted utensil 320 that is mounted on the base module. Utensil 320 can contain liquid materials, such as oil or water; the height of utensil 320 from the heating element 160 is determined by the relations between opening 360 and the thicknesses of extension ring 310, which is preferably substantially conical; preferable utensils like utensil 320 can be of different heights for holding different amount of liquid.

An additional utensil 330 is provided on top and within utensil 320; wherein utensil 330 is a frying net basket capable of being inserted into utensil 320. The food inside utensil 330 is mixed by rotating wings 340. Cap 350 is capable of holding rotating wings 340 in place.

It should be noted that supporting rings 310, preferably conically shaped, can be provided in different heights and sizes so as to raise the utensil, like 320, and also different pans from the heating source.

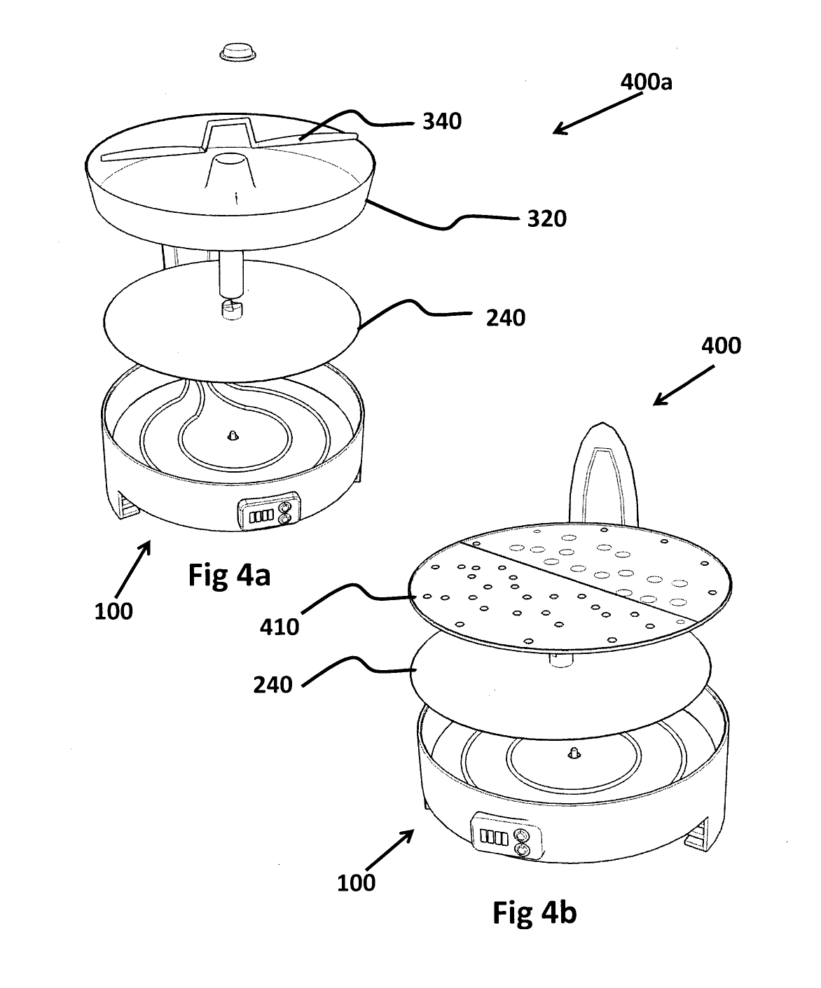

Reference is now made to FIGS. 4a and 4b illustrating multifunctional pot 400a designed for cooking and multifunctional pot 400 for steam cooking, in accordance with preferred embodiments of the present invention. Multifunctional pot 400 is provided with base module 100 which is similar to the embodiments shown in FIGS. 1 a-c. Pan 410 is mounted on top of utensil 320 (not shown in FIG. 400) it has plurality of holes of different sizes that are adapted to allow hot air to easily transfer from the bottom, or to allow steam transfer from utensil 320 to 410 where vegetables can be placed, for example; steam and hot air can go higher to the level of the cover 140. Optionally, half of pan 410 can be lifted on axis 420 to enable pouring water into utensil 320. Serving dishes such as vegetables are mostly desired to be cooked in an evaporation mode which is possible using this type of pans. Pans 240 and 410 are placed in multifunctional pot 100 in a level that is relatively lower than the rim 190 so as to establish sufficient space between the openings onto which lid 140 can be placed.

FIG. 400a provides a backing and cooking option with rotating wings 340 for steering the food in utensil 320. Optionally utensil 320 can be of different depths, allowing more type of serving dishes to be prepared in this utensil. Mixers 340 revolve about the center of the pan using extension spindle 170. Rotating wings 340 can be in a verity of sizes, in different length or different width, and are capable of reaching the bottom of utensil 320. Rotating wings 340 may have pedals that can be adjusted in any angle relative to the bottom surface of pan 320 and can also revolve about their axle so as to establish better mixing properties. Each paddle can be adjusted in another angle then the other.

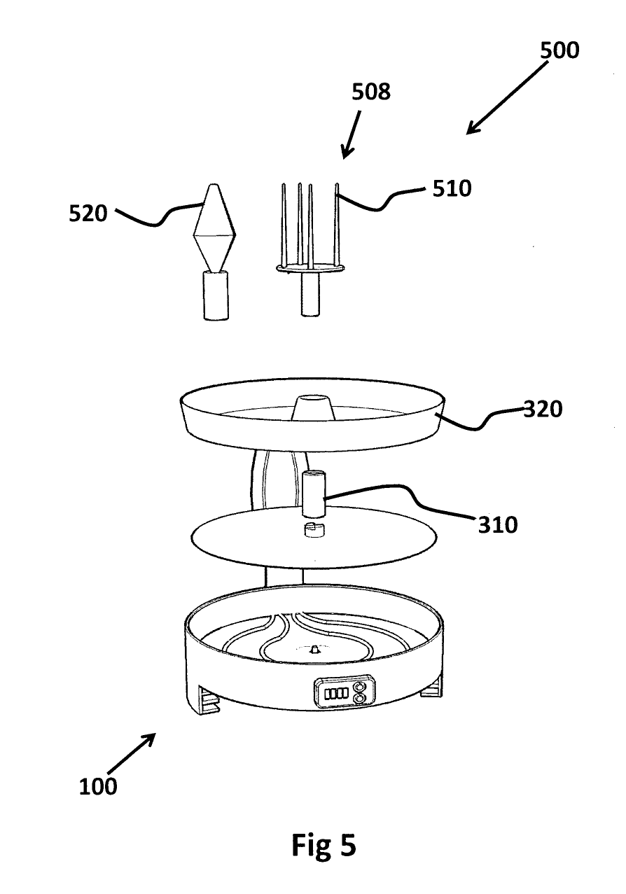

Reference is now made to FIG. 5 illustrating multifunctional pot with a verity of utensils for cooking in accordance with a preferred embodiment of the present invention. Onto base module 100 fluted utensil 320, as shown before, is placed and skewers 508 are mounted to be used for cooking foods such as sausages and pieces of meat that can be cooked and warmed when pined onto pins 510 that may be of different sizes and lengths. Utensil 520 is adapted to hold a chicken (in upright position) to be cooked. Both utensils 508 and 520 are capable of rotating by motor extension 170.

When a chicken is to be cooked, due to its size, an extension of the sides of the pot is a necessity in order to form an oven-like structure. Therefore, ring extensions are provided as will be shown.

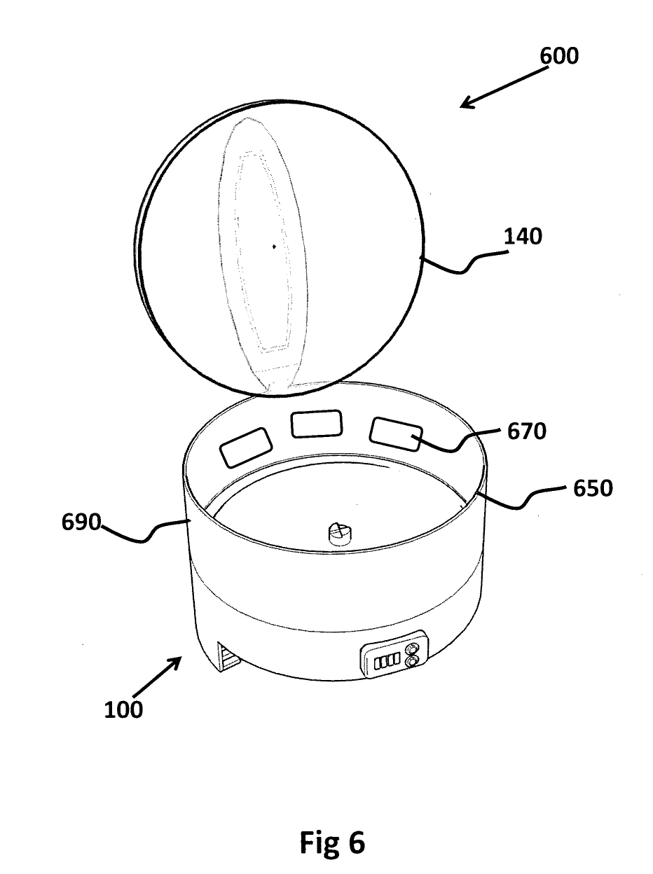

Reference is now made to FIG. 6 illustrating multifunctional pot provided with a chicken oven utensil in accordance with another preferred embodiment of the present invention. The pot can be provided with a ring-type or cylinder extension 650 of different heights that is adjacently provided in the circular dent 190 on the circumference of base module 100. Cylindrical extension is upwardly extending the sides of base module 100.

Optionally and in order to make the heating process more effective, extension 650 is provided with heating bodies 670. Preferably, extension 650 is double-walled built. In case of grilling or boiling sausages or chicken, the extension can be provided in order to grill the whole extent of the food. A door 690 is provided in order to facilitate the treatment of the food during the cooking process. Extensions of different heights can be optionally provided. Lid 140 is also provided wherein there is a need to provide an option to extend the height of the lid according to the use of the utensils or extension sides.

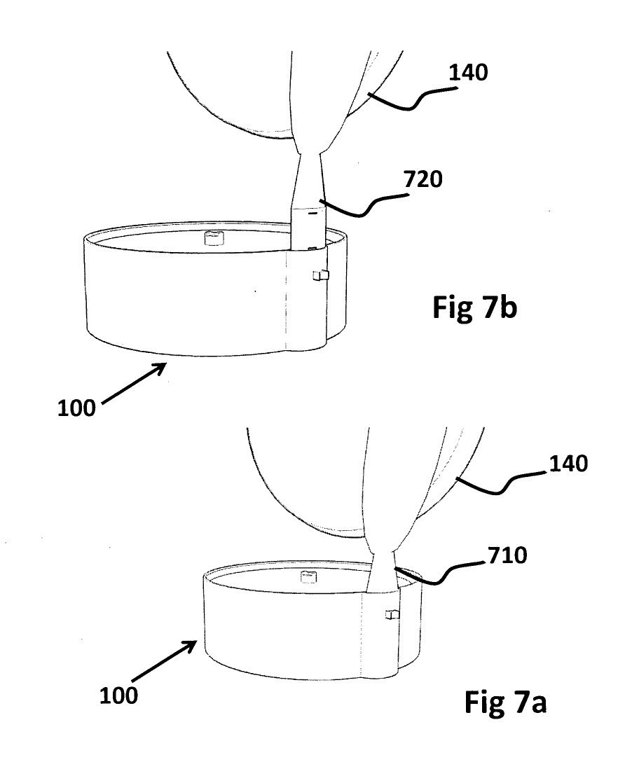

Reference is now made to FIGS. 7a and 7b illustrating multifunctional pot wherein the lid is in different heights. The lid 140 is connected to a mounting axis 710 is presented in two states. In FIG. 7a, lid 140 is in a low position and in FIG. 7b, lid 140 is mounted on an extension of 720 so as to provide height and establish high position relative the base module 100. Extension 720 can be adjusted so as to enable closure of the pot in different heights according to the utensils that are being used.

1. A multifunctional pot assembly comprising
a base module comprises a pot-like base having an upper opening, operation control mechanism, at least one heating element from which a first heating element is positioned in said pot-like base, and an inner cover for concealing said first heating element;
a revolving element attached to a motor; wherein said revolving element extends above said inner cover in said upper opening;
at least one utensil, wherein the utensils can be mounted on said upper opening and are capable of revolving by said revolving element.

2. The pot assembly as claimed in claim 1, wherein the pot has a round shape.

3. The pot assembly as claimed in claim 1, wherein the pot-like base is provided with a mounting axis and a lever extending horizontally from the axis and a lid is mounted on the lever that extends over the opening of the pot-like base and can be position in different heights over the opening.

4. The pot assembly as claimed in claim 3, wherein a second heating element from said at least one heating element is provided within said lever, and can be a griller.

5. The pot assembly as claimed in claim 1, wherein said operation control mechanism controls said at least one heating element through a console having elements such as on/off buttons, control heating level knobs, and indicating lamps.

6. The pot assembly as claimed in claim 1, wherein the pot-like base is provided with supporting legs provided with racks that are capable of serving as storage space for said utensils.

7. The pot assembly as claimed in claim 1, wherein the rim of the sides of said pot-like base is provided with a dent capable of mounting extensions walls of different heights.

8. The pot assembly as claimed in claim 7, further provided with double-walled extension of different heights that can be mounted on said dent in the rim on the pot-like base.

9. The pot assembly as claimed in claim 8, wherein said double-walled extension is provided with third said heating element.

10. The pot assembly as claimed in claim 1, wherein said at least one utensil is a flat shaped pan with small holes.

11. The pot assembly as claimed in claim 1, wherein said at least one utensil is a flat shaped pan provided with folds, a lifted rim and a dent on a circumference of the pan.

12. The pot assembly as claimed in claim 1, wherein said at least one utensil is a flat shaped pan with plurality of flat recesses.

13. The pot assembly as claimed in claim 12, wherein the plurality of flat recesses are interconnected to a central recess.

14. The pot assembly as claimed in claim 1, further provided with a spindle capable of being connected to said revolving element and wherein said spindle is of conical shape allowing said at least one utensil to be mounted on it.

15. The pot assembly as claimed in claim 14, wherein said at least one utensil is a bowl like structure with a raised hole and is capable of being mounted over said spindle.

16. The pot assembly as claimed in claim 15, wherein on top of said bowl like structure mounted a flat pan designed for steaming, wherein said flat pan has holes and axis on the diameter capable of being lifted half said pan on said axis.

17. The pot assembly as claimed in claim 15, wherein said bowl like structure further capable of being mounted over said spindle wherein the spindle extends beyond the bowl surface.

18. The pot assembly as claimed in claim 17, wherein said utensil is a frying net basket capable of being mounted on the spindle inside said bowl and wherein the spindle extends beyond said net basket surface.

19. The pot assembly as claimed in claim 17, wherein said at least one utensil is a rotating pedals mechanism for steering, wherein said rotating pedals are positioned on top of said spindle.

20. The pot assembly as claimed in claim 19, wherein said rotating pedals can be adjusted in any angle relative to a bottom surface of said at last one utensil.

21. The pot assembly as claimed in claim 20, wherein said rotating pedals have an axle around which said rotating pedals can paddle and said rotating pedals can be adjusted each in different angle then the other.

22. The pot assembly as claimed in claim 1, further provided with a skewers utensil capable of being mounted on said revolving element and wherein the skewers may be of different sizes and lengths.

23. The pot assembly as claimed in claim 1, further provided with a chicken mounting utensil capable of being mounted on said revolving element.
